(19) United States
(12) Patent Application Publication
(10) Pub. No.: US 2011/0131997 A1
(43) Pub. Date: Jun. 9, 2011

(54) APPARATUS FOR ACQUIRING MECHANICAL ENERGY ON THE BASIS OF CO-OPERATIVE ACTION OF THE GRAVITATIONAL EFECT AND REDUCED FRESSURE

(76) Inventor: Jiri Frolik, Praha (CZ)

(21) Appl. No.: 12/737,660

(22) PCT Filed: Jul. 27, 2009
(86) PCT No.: PCT/CZ2009/000095

§ 371 Date: Jan. 25, 2011

(30) Foreign Application Priority Data
Jul. 28, 2008 (CZ) PV 2008-463

(51) Int. Cl. F03G 3/02

(52) U.S. Cl. 60/717

(57) ABSTRACT

An apparatus for acquiring mechanical energy on the basis of the gravitational effect and reduced pressure, comprising at least one double-acting hollow piston (1) accommodated in a horizontally oriented cylinder (2), the essence of which re-sides in that the double-acting hollow piston (1) is provided with centrally and mutually oppositely arranged hollow piston rods (3, 3.1) that are equipped with steam inlets (4, 4.1), wherein a free end of a first hollow piston rod (3) that is closer to a first vertical elevator carrier (6) is connected to a first weight cable (5) that is guided over a first pulley system (6.2) and a free end of an oppositely oriented second hollow piston rod (3.1) that is closer to a second vertical elevator carrier (6.1) is connected to a second weight cable (5.1) that is guided over a second pulley system (6.3), wherein a first weight (7) that is slidably supported on a first guiding rod (8) is connected to the opposite end of the cable (5) and a second weight (7.1) that is slidably supported on a second guiding rod (8.1) is connected to the opposite end of the cable (5.1) and wherein the first weight (7) is provided with a first cable clamping element (9), through which an endless first elevator cable (10) passes and the second weight (7.1) is provided with a second cable clamping element (9.1) through which an endless second elevator cable (10.1) passes, wherein the endless first elevator cable (10) is connected to a first transmission system (19) of the first elevator and a first electric generator (12) and the endless second elevator cable (10.1) is connected to a second transmission system (19.1) of the second elevator and a second electric generator (12.1).

### FIELD OF THE ART

The invention relates to an apparatus for acquiring mechanical energy on the basis of co-operative action of the gravitational effect and reduced pressure, which is primarily destined as an autonomous driving unit at locations with limited access for standard energies and which can be utilized in technologically less demanding operations.

### PRESENT STATE OF THE ART

In current practice, there exist known apparatuses that utilize the Earth's gravity for the acquisition of mechanical, or, as the case may be, electrical energy. Examples include water wheels and, primarily, water turbines, which utilize the gravitational energy of water present in watercourses. The energy that maintains the perpetual circulation of water in watercourses is supplied by the sun which causes the evaporation from water surfaces all over the globe that takes place without interruption and with unceasing intensity. However, despite this fact, it is not possible to increase the degree of utilization of the gravitational energy of the watercourses without limit, because only a part of the watercourses exhibits a suitable topography for the erection of dams or other waterworks for the utilization of their gravitational energy. The gravitational attraction is able to act on any mass with terrestrial acceleration only in the direction toward the surface, or more precisely toward the center, of Earth. On the surface of Earth, the gravitational acceleration amounts to approximately 9.81 m/s² (about 32 ft/s²), but it acts on bodies leaving the sphere of Earth's gravity in the opposite direction, away from the Earth's surface, as a braking force. The magnitude of the gravity is directly proportionate to the mass of the object and indirectly proportionate to the distance of the object from the center of gravity.

In spite of this, molecules of water vapor evaporated by the sun's radiation rise, owing to the co-operation of atmosheric phenomena, against the gravity into considerable altitudes, where they condense to form fog, constitute rainclouds and precipitation of water in the form of rain is encountered in the event that condensation nuclei, such as, for instance, dust particles, aerosols and the like are present, with simultaneous cooling of the atmosphere. The thus precipitated water then constantly supplies the watercourses flowing into lowlands and into the seas. The sun's radiation thus is able to transport the water molecules in the form of water vapor into a certain space against the influence of gravity, and it is then possible to utilize the thus acquired gravitational energy of the water flowing in the watercourses for powering machines.

Another one of the above-mentioned phenomena is vacuum. It is known that if, for instance, water vapor contained in a cylinder closed by a sealed piston is cooled, the vapor condenses into liquid water and vacuum comes into existence underneath the piston. The ambient atmospheric pressure then presses on the outer surface of the piston and pushes the piston, together with the piston rod, into the interior of the cylinder. The so-called atmospheric motors then utilize this force for the genesis of mechanical energy. This principle of formation of vacuum is also being utilized in the condensers of steam turbines, where very effective vacuum is created by efficient cooling, which vacuum keeps the water vapor in a gaseous state at a very low pressure, so that the water vapor emerging from the last stage of the steam turbine is being maintained in its gaseous state at a temperature considerably below its natural condensation temperature, i.e. 100° C. (212° F.), such as, for example, 30° C. (86° F.). In this way, the occurrence of cavitation is avoided and the output of the turbine is substantially increased.

Historically the first utilization of the vacuum generated by the condensation of water vapor due to cooling of the outer surface of the cylinder by cold water for the acquisition of mechanical work was made possible by the Newcomen steam engine, which served for the drawing water from deep ore and coal mines. This machine consisted of a rocker constituted by a wooden beam, wherein this beam was connected by chains on the one side to the piston of the engine, while a second piston—the plunger of a lifting pump—was connected to the other side of the rocker. When vacuum was created underneath the piston, the latter was intensely moved down by the atmospheric pressure opposing the vacuum into the lowermost position of the piston, and the plunger situated at the other side of the rocker lifted the water into an outlet pipe,

However, the efficiency of the machine was low, because the heating source was located directly below the cylinder in which there was accommodated the piston that had to be lifted after the completion of the cooling phase into its upper position by the creation of a sufficient pressure of the steam underneath the piston and in this manner the second phase was performed which resulted in the immersion of the plunger of the pump in its lower position on the other side of the rocker. In essence, what is encountered here is a single-acting piston engine in which the return stroke of the piston did not perform any work

A further known state of the art is the utilization of vacuum in atmospheric railway vehicles which were connected with a piston located on a railway superstructure in a longitudinally extending tube provided with a longitudinal slot closed by sealing flaps, wherein air was evacuated from in front of the piston by means of air pumps, as a result of which subatmospheric pressure came into being in the space ahead of the piston and the atmospheric pressure prevailing behind the piston caused the piston and simultaneously with it even the vehicle to move forward. This solution is described, for instance, in older English technical literature radily available, for example, on the web site of the free encyclopedia Wikipedia in the article entitled “Atmospheric Railway”.

Even with this solution one may see disadvantages residing in a relatively expensive technological and structural solution of this equipment that requires a considerable amount of peripheral devices and systems.

It is a goal of the invention to utilize the force exerted by the atmospheric pressure on a piston following the cooling of the steam in the cylinder with the aid of the thus generated vacuum to cause a weight to gain potential energy and, by using the atmospheric pressure acting against the partial vacuum in the cylinder, to lift the weight to a higher elevation and to use the same for constructing a machine as a double-acting system in which the dead stroke of the piston is compensated by the energy from the return stroke.

### ESSENCE OF THE INVENTION

The disadvantages of the known machines are to a great extent eliminated and the goal of the technical solution is accomplished by an apparatus for acquiring mechanical energy on the basis of the gravitational effect and reduced pressure, consisting of at least one double-acting hollow piston accommodated in a horizontally oriented cylinder according to the invention, the essence of which resides in that the double-acting hollow piston is provided with centrally and mutually oppositely arranged hollow piston rods that are equipped with steam inlets, wherein a free end of a first hollow piston rod that is closer to a first vertical elevator carrier is connected to a first weight cable that is guided over a first pulley system and a free end of an oppositely oriented second hollow piston rod that is closer to a second vertical elevator carrier is connected to a second weight cable that is guided over a second pulley system, wherein a first weight that is slidably supported on a first set of guiding rods is connected to the opposite end of the first weight cable and a second weight that is slidably supported on a second set of guiding rods is connected to the opposite end of the second weight cable and wherein the first weight is provided with a first cable clamping element through which an endless first elevator cable passes and the second weight is provided with a second cable clamping element through which an endless second elevator cable passes, wherein the endless first elevator cable is connected to a first transmission system of the first elevator and a first electric generator and the endless second elevator cable is connected to a second transmission system of the second elevator and a second electric generator.

A first working space of the cylinder is provided with a first air exhaust equipped with a first air closing element and a first electromagnetic valve and a second working space of the cylinder is provided with a second air exhaust equipped with a second electomagnetic valve, wherein cylinder draining channels are formed in the lower region of the horizontally extending cylinder.

The first draining channel communicates with the first cylinder working space and the second draining channel communicates with the second cylinder working space.

The cross-section of the hollow double-acting piston is advantageously of a square shape.

The advantages of the apparatus according to the technical solution reside, above all, in the separate withdrawal of torque from the piston section of the machine due to the use of an endless elevator that is being repeatedly activated by means of an alternatingly connected weight, and that the torque is furthermore stabilized by a flywheel. The apparatus is suitable for use as a source of electrical energy in the process of incineration of biomass and in similar operations.

### OVERVIEW OF THE FIGURES OF THE DRAWING

To provide for a better understanding of the invention, the apparatus in accordance with the invention is diagrammatically shown in the accompanying drawing, in which

FIG. 1 shows, in a lateral view, the overall layout of the apparatus and, in a partial longitudinal section, an end cylinder with the double-acting piston, and

FIG. 2 shows, in a view taken on line A-A, instantaneous positions of the individual weights of the adjacently arranged sections of the machine and their phase shift.

### EXAMPLE OF THE EMBODIMENT OF THE INVENTION

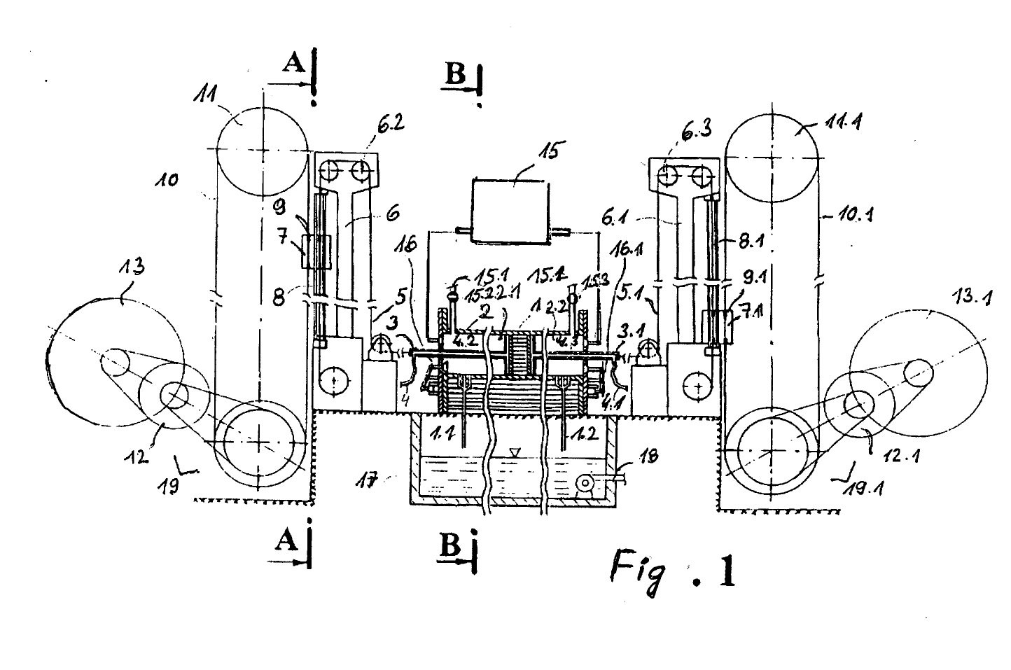

The overall layout of the machine is evident in a lateral view in FIG. 1, in which there is visible, in the central region, in a partial section, a horizontally oriented end cylinder 2 with a first working space 2.1 of the cylinder and with a second working space 2.2 of the cylinder, in which there is accommodated a double-acting piston 1 with centrally and mutually symmetrically and oppositely arranged hollow first piston rod 3 and a hollow second piston rod 3.1, which are provided at their free ends with a first cooling water inlet 4 and a second cooling water inlet 4.1 and the end portions of which are further connected with a free end of a first weight cable 5 and with a free end of a second weight cable 5.1. By means of pulleys supported on a first vertical weight carrier 6 and on a second vertical weight carrier 6.1, the first weight cable 5 is connected with a first weight 7 and the second weight cable 5.1 is connected with a second weight 7.1, where the first weight 7 is slidably supported on a first weight guiding rod 8 and the second weight 7.1 is slidably supported on a second weight guiding rod 8.1. The first weight 7 is connected, by means of a first cable clamping element 9, with a first endless cable 10 of a first elevator and the second weight 71 is connected, by means of a second clamping element 9.1, with a second endless cable 10.1 of a second elevator. The first elevator 11 is connected, by means of a first transmission system 19 provided with a first flywheel 13 with a first electric generator 12 and a second elevator 11.1 is connected, by means of a second transmission system 19.1 equipped with a second flywheel 13.1, with a second electric generator 12.1. The first working cylinder space 2.1 that is closer to the first elevator 11 is provided with a first inlet 15.1 for steam from a steam container 15 and with a first atmospheric air inlet 16 and the second working cylinder space 2.2 that is closer to the second elevator 11.1 is provided with a second inlet 15.2 for steam and with a second atmospheric air inlet 16.1.

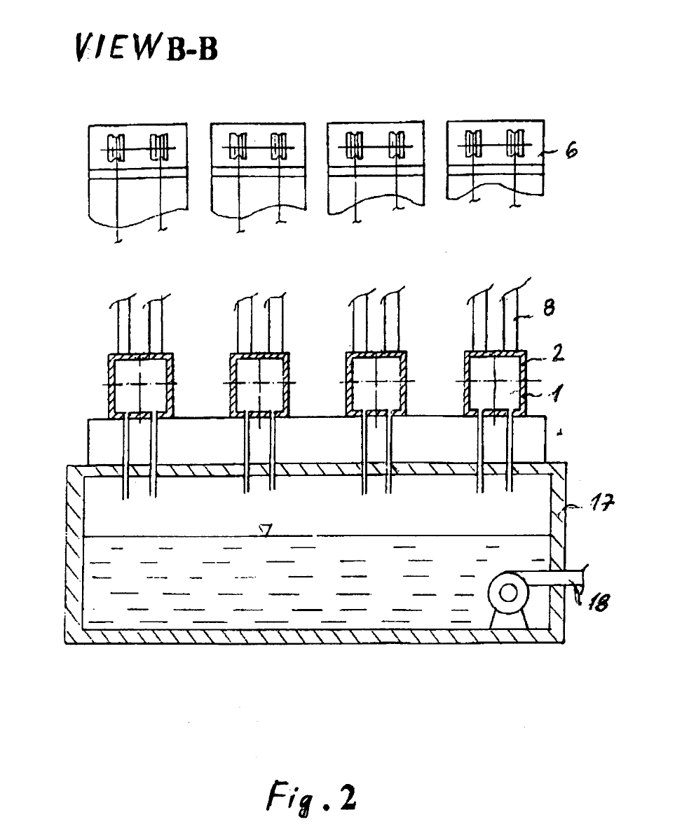

In FIG. 2 there is visible the arrangement of individual horizontally oriented cylinders 2 next to each other and their square cross-section, wherein draining channels of the cylinder are indicated as well.

### REFERENCE CHARACTERS

1—double-acting hollow piston
1.1—first draining channel of the cylinder
1.2—second draining channel of the cylinder
2—horizontally extending cylinder
3—first hollow piston rod
3.1—second hollow piston rod
4—first cooling water inlet
4.1—second cooling water inlet
5—first weight cable
5.1—second weight cable
6—first vertical weight carrier
6.1—second vertical weight carrier
7—first weight
7.1—second weight
8—first weight guiding rod
8.1—second weight guiding rod
9—first weight clamping element
9.1—second weight clamping element
10—first elecator cable
10.1—second elevator cable
11—first elevator
11.1—second elevator
12—first electric generator
12.1—second electric generator
13—first flywheel
13.1—second flywheel
14—first air valve
14.1—second air valve
15—steam storage container
16—first valve
16.1—second valve
17—condensed water collection receptacle
18—circulation pump
19—first transmission system
19.1—second transmission system

1. An apparatus for acquiring mechanical energy on the basis of the gravitational effect and reduced pressure, comprising at least one double-acting hollow piston (1) accommodated in a horizontally oriented cylinder (2), characterized in that the double-acting hollow piston (1) is provided with centrally and mutually oppositely arranged hollow piston rods (3, 3.1) that are equipped with steam inlets (4, 4.1), wherein a free end of a first hollow piston rod (3) that is closer to a first vertical elevator carrier (6) is connected to a first weight cable (5) that is guided over a first pulley system (6.2) and a free end of an oppositely oriented second hollow piston rod (3.1) that is closer to a second vertical elevator carrier (6.1) is connected to a second weight cable (5.1) that is guided over a second pulley system (6.3), wherein a first weight (7) that is slidably supported on a first guiding rod (8) is connected to the opposite end of the cable (5) and a second weight (7.1) that is slidably supported on a second guiding rod (8.1) is connected to the opposite end of the cable (5.1) and wherein the first weight (7) is provided with a first cable clamping element (9), through which an endless first elevator cable (10) passes and the second weight (7.1) is provided with a second cable clamping element (9.1), through which an endless second elevator cable (10.1) passes, wherein the endless first elevator cable (10) is connected to a first transmission system (19) of the first elevator and a first electric generator (12) and the endless second elevator cable (10.1) is connected to a second transmission system (19.1) of the second elevator and a second electric generator (12.1).

2. Apparatus for acquiring mechanical energy according to claim 1, characterized in that a first working space (2.1) of the cylinder is provided with a first air exhaust (15) equipped with a first air closing element (15.2) and a first electomagnetic valve (16) and a second working space (2.2) of the cylinder is provided with a second air exhaust (15.3) equipped with a second electomagnetic valve (16.1), wherein cylinder draining channels (1.1, 1.2) are formed in the lower region of the horizontally extending cylinder (2).

3. Apparatus for acquiring mechanical energy according to claim 2, characterized in that the first draining channel (1.1) communicates with the first cylinder working space (2.1) and the second draining channel (1.2) communicates with the second cylinder working space (2.2).

4. Apparatus for acquiring mechanical energy according to claim 3, characterized in that the cross-section of the hollow double-acting piston (1) is advantageously of a square shape.

5. Apparatus for acquiring mechanical energy according to claim 4, characterized in that the first transmission system (19) is equipped with a first flywheel (13) and the second transmission system (19.1) is equipped with a second flywheel (13.1).
